(19) United States
(12) Patent Application Publication
(10) Pub. No.: US 2020/0191317 A1
(43) Pub. Date: Jun. 18, 2020

(54) AEROGEL CLAMSHELL INSULATION

(71) Applicant: JOHNS MANVILLE, Denver, CO (US)

(72) Inventors: Christopher McBride, Golden, CO (US); Christopher James Griffin, Aurora, CO (US); Jason Koravos, Chelmsford, MA (US)

(21) Appl. No.: 16/222,358

(22) Filed: Dec. 17, 2018

(51) Int. Cl. F16L 59/02; F16L 59/08

(52) U.S. Cl. CPC F16L 59/024; F16L 59/08; F16L 59/028

(57) ABSTRACT

An insulation product for a pipe-in-pipe pipeline having a clamshell assembly formed of a lightweight, semi-rigid material forming an annular cylinder when closed around a pipe and configured to fill an internal space of a pipe-in-pipe pipeline system. The annular cylinder is split into multiple sections, each section having an internal void filled with insulating material, such as aerogel. The multiple sections are connected by flexible portions or hinges. The aerogel insulation is contained within a section of the annular cylinder. The clamshell assembly is quickly and simply installed to a pipeline and accepts a wide variety of insulation types and forms to reduce production time and expense.

### BACKGROUND

Industrial pipelines are sometimes configured as a pipe-in-pipe system with an inner pipe carrying the fluid to a destination, the inner pipe surrounded by insulation, the inner pipe and insulation shielded or protected by an outer pipe. As one example, offshore oil and gas recovery operations are continually expanding to deeper and more remote locations. It is cost prohibitive to install surface operations for each location. A single platform may serve as a central hub connected to satellite wells and remote platforms through subsea pipelines. Temperature control is of vital importance in oil flow pipelines. When the temperature inside the pipeline drops below a certain point, referred to as a cloud point, waxes begin to precipitate from the oil and accumulate along the pipe. The accumulations of wax restrict oil flow and therefore cause the pipeline to require more energy to keep flowing. Additionally, below a certain point, the oil may become semisolid due to precipitates. A pipe-in-pipe configuration allows for high insulation performance which cannot be matched by simple pipe coatings. The insulation minimizes heat losses from the traveling fluid to the environment thereby increasing the efficiency and flow of the pipeline. The gains of the pipe-in-pipe system for efficiency and flow rate are balanced by the need to minimize the pipeline cost. Larger diameter pipe comes at a higher cost for materials and for installation so it is desirable to provide high levels of insulation with the lowest possible material and labor costs. Aerogel is often used as an insulating material in these pipelines because it provides high levels of thermal insulation with a small thickness. Currently implemented packs of aerogel insulation or blankets can be costly and time consuming to install, thereby increasing pipeline costs.

### BRIEF DESCRIPTION

This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Embodiments of the disclosure relate to an insulation and insulation systems for pipes. The insulation and insulation systems described herein provide thermal performance with minimal thickness and provide for easy and cost-effective installation in a pipeline. The present disclosure may be useful for applications involving seabed tieback lines for oil flow. In one example subsea or seabed tieback oil pipelines, an inner pipe carries the oil from one location to another, typically from subsea equipment or risers to vessels or platforms. The inner pipe is surrounded by insulation and shielded on the outside by an outer pipe. The primary purpose of the outer pipe is to provide protection for the inner pipeline. However, the present disclosure is useful and applicable for providing insulation to any pipeline.

In one aspect, an insulation product for a pipe-in-pipe application, the insulation product is designed to minimize thermal losses to the environment. The insulation product may include aerogel insulation, or may also include opacifiers or other insulation products. The insulation products used herein should have high thermal resistance value. In some embodiments, the aerogel or other insulation products may be in a particulate form while in other embodiments the aerogel or other insulation products may be in sheet or blanket form. The ability to use particulate insulation or leftover insulation scraps from insulation production provides an opportunity to provide effective insulation at a significantly lower cost.

In some embodiments the insulation product is contained within a hollow vessel in the shape of an annular cylinder. The center of the annular cylinder contains an inner pipe of a pipe-in-pipe system. In some embodiments the hollow vessel is formed from a lightweight rigid or semi-rigid material, one non-limiting example of such a material is PVC. In some embodiments the hollow vessel has a length suitable for easy installation by workers. In other embodiments, the hollow vessel may be of a length designed to fit between spacers or centralizers of the pipeline.

Embodiments of the disclosure relate to an easy to install assembly for an insulation unit designed to fill an interstitial space between an inner pipe and an outer pipe of a pipe-in-pipe pipeline. In some embodiments, the insulation unit has two primary insulation units or sections. The insulation sections are designed to fit around a pipe and within another pipe, therefore in some embodiments of the present disclosure each section is a half of an annular cylinder. In other embodiments the two sections may have different shapes or differ from each other. For ease of installation, the two sections are hinged along a longitudinal edge using any suitable hinging mechanism. The two sections may be opened and then put in place and closed around the inner pipe so as to completely surround the inner pipe with an equal thickness of insulation in every radial direction around the pipe. The sections are secured with a latch, or in other embodiments, a band or any suitable low-profile connecting mechanism.

In some embodiments of the disclosure, the pipe-in-pipe system includes centralizers or spacers spaced from each other by a specified distance and designed to hold the inner pipe concentrically within the outer pipe. The centralizers may be built onto an insulation unit of the disclosure. In other embodiments, the centralizers may contain recesses or slots into which the insulation units slide and are secured. The centralizers having recesses may secure the insulation units precluding the need for a separate securing mechanism or a hinge.

In another aspect, a method of installing an insulation unit on a pipe-in-pipe system is provided. The method may include forming an insulation unit having a thin-walled body filled with an insulating material. The insulating material may be in sheet form, particle form, or blanket form and may be primarily an aerogel insulation or a mixture of aerogel and another insulating material or in some embodiments may be any appropriate insulating material. The thin-walled body is shaped to fit within the space between the inner and outer pipe of a pipe-in-pipe system. The thin-walled body may also be configured, in some embodiments to open and close, allowing access and easy installation onto the inner pipe. After the thin-walled body is closed around the inner pipe, it may be secured in place. The inner pie is then placed within or surrounded by the outer pipe, thereby forming the pipe-in-pipe system.

In some embodiments of the disclosure, a method of forming or constructing an easy to install insulation unit for a pipe-in-pipe system is provided. The method may include forming or providing a thin-walled shell made of a rigid or semi-rigid material. The shell may be formed as a partial annular cylinder, or in other words, may have a cross section having a u-shape or an arch-shape. After forming the shell a filling spout or opening is formed in a surface of the insulation unit. Alternately, the filling spout or opening may be shaped in the body of the insulation unit during the forming process. The shell is then filled with an insulating material, such as aerogel. The insulating material may be small pieces or insulation or may be larger intact pieces such as insulation packets designed to fill the entire thin-walled shell. The insulating unit is sealed after filling with insulating material. A second insulating unit having a similar shape is provided, produced in the same manner as the first insulation unit. More than two insulation units may be provided, so long as the completed insulation part is capable of completely surrounding a diameter of a pipe. The several insulation units are secured to each other with a latch or other pivotal mechanism. In some embodiments, the several insulation units may be releasably secured together using a suitable securing mechanism such as a latch, band, strap, tape or any other securing device.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label. The present disclosure is described in conjunction with the appended figures:

FIG. 1 is a perspective view of a pipe-in-pipe system with insulation units.

FIG. 2 is a perspective view of a portion of an insulation unit.

FIG. 3 is a section view of a portion of an insulation unit.

FIG. 4 is a section view of a hinge of an insulation unit.

### DETAILED DESCRIPTION

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the description relate to an insulation unit, insulation device, and insulation systems for pipe-in-pipe systems, pipes, storage tanks, or other vessels. The insulation systems described herein use at least one layer of insulation, such as aerogel, to provide thermal and/or acoustic insulation. The insulation systems described herein may provide an insulation unit that fits in a space between walls of concentric pipes in a pipe-in-pipe system. The pipe-in-pipe insulation system is designed to insulate both pipe-in-pipe pipelines as well as traditional single pipe pipelines. The systems described herein are designed to provide insulation using a simple to install system that is also capable of using small pieces of insulation, such as scraps or shreds left over from other processes thereby reducing waste and expense.

Aerogels, as described herein, include porous ultralight materials derived from gels, where a liquid component of the gel has been replaced with a gas. Aerogels can include silica, carbon-based aerogels, metal oxide aerogels, organic polymers, and the like. The aerogels used in the present description are good thermal insulators because they significantly reduce the effects of conductive and convective heat transfer. Due to the large proportion of gases (which are poor heat conductors) within aerogels, the aerogels are good conductive insulators. Silica aerogel is an especially good insulator because silica is also a poor conductor of heat. The aerogels are good convective inhibitors due to the Knudsen effect, whereby air cannot circulate through the lattice structure of the compounds resulting in decreased thermal conductivity and eliminating convection.

In some embodiments, the insulation unit may be filled with aerogel particles, such as, but not limited to, silica aerogel particles (i.e. Cabot® P200 aerogel particles, P300, and/or P400 aerogel particles). In some embodiments, Aerova® aerogel powder (available from JIOS Aerogel Corporation), or other alternative silica aerogels may be used alone or in combination with other aerogels.

The aerogel particles are synthetic highly porous and ultralight weight materials. The aerogel particles are typically made through a sol-gel process, although any other process of forming the aerogel particles known in the art may be employed. The aerogel particles are excellent thermal insulators due to being extremely light weight, low density (i.e., 98% air), and having extremely small pore sizes, which typically are between 10 nm and 40 nm. The nano-sized pores of the aerogel particles enable the aerogel particles to exhibit low thermal conductivity by essentially eliminating convection and gas conduction heat or thermal energy transfer. In some embodiments, the aerogel particles used for making the insulation product may include hydrophobic silica aerogel particles. In some embodiments, the aerogel particles may also include various other materials, such as organic aerogels, polyimide aerogel, polyurethane aerogel, and the like. A more thorough or complete description of the aerogel particles is provided in U.S. patent application Ser. No. 15/804,834, the entire disclosure of which is hereby incorporated by reference.

In some embodiments, the aerogel or other insulation may have additional additives or other components incorporated into and mixed within the shell of the insulation unit. As just one example, carbon black or other opacifier may be added to the aerogel particles to reduce static and to reduce thermal conductivity at temperatures near and above 0° F. Other examples of opacifiers may include titanium dioxide, ferrous titanate. Other additives may include perlite, various foams, or other insulation alternatives.

In some embodiments, the insulation unit may be formed into a thin-shelled hollow vessel having a shape resembling a section or segment of an annular cylinder. The thin shell or outer component of the insulation unit is formed of a lightweight, rigid, or semi-rigid material. Some examples of materials which may be suitable for forming the thin-shell include PVC, vinyl, ABS, polypropylene, PET, or other similar materials. Additionally, in some embodiments, the shell may be formed or made from thin metallic sheets, such as rolled aluminum, rolled steel, or any other suitable metal. In any embodiment, the thickness of the thin-shell portion of the insulation unit is preferably as small or as thin as practicably possible. The thickness of the shell should be as thin as possible, while still thick enough to support and maintain the structure of the shell of the insulation unit. Because the pipe-in-pipe systems of the disclosure include an outer pipe to provide protection and shielding for the inner pipe, the shell of the insulation unit does not need to provide strength or support for the outer pipe. Additionally, the insulating properties of the insulation material, such as aerogel, are likely to exceed or insulate better than the material used to form the shell of the insulation unit so it is advantageous to minimize the thickness of the shell to provide the highest level of insulation for the inner pipe.

In some other embodiments, the thin shell of the insulation unit may be formed or made from a flexible or formable material. In such an embodiment, the insulation unit may still be filled with an insulation material according to embodiments of the disclosure. Rather than being shaped as a clamshell, the insulation unit may be in a flat or substantially flat arrangement which can be wrapped around the inner pipe and secured in place. In yet other embodiments, the clamshell pieces may be formed of a flexible material to allow the insulation unit to shift during installation for ease of installation. One example of a flexible material is a hard rubber.

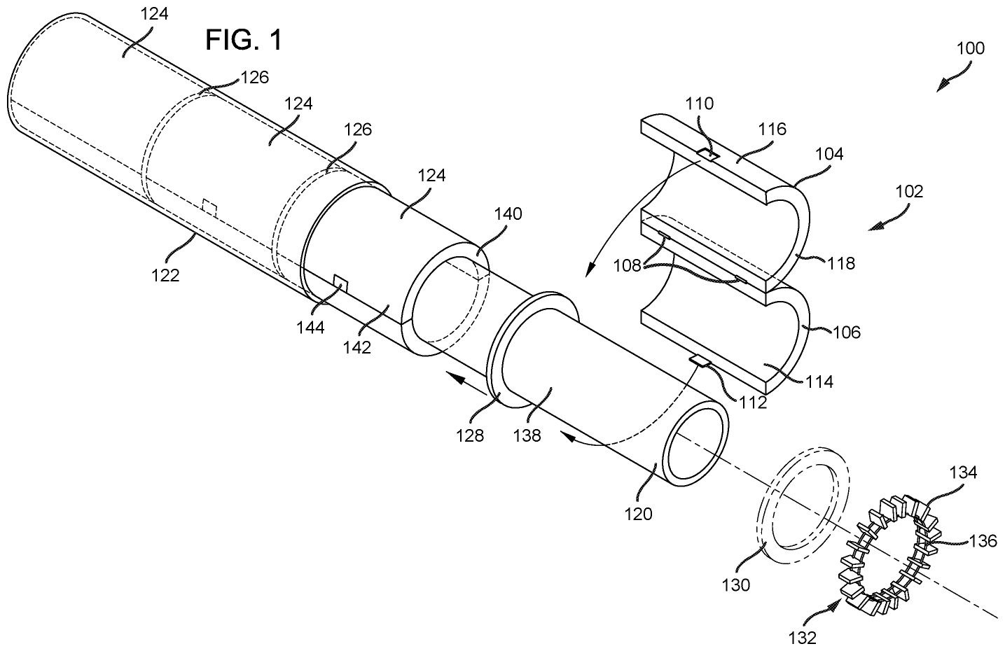

Turning now to the figures, FIG. 1, shows an example embodiment of a clamshell insulation unit applied to a pipe-in-pipe system 100. The pipe-in-pipe system 100 includes a number of different components to provide insulation and protection for a pipeline according to embodiments of the disclosure. The pipe-in-pipe system 100 may include an inner pipe 120 through which material, such as oil and gas, flows from one location to another. The inner pipe 120 may be configured to provide a flow of material from as a seabed tieback line. The inner pipe 120 is surrounded concentrically with a number of insulation units 124 along the length of the inner pipe 120 such that an inner surface of the insulation units 124 is configured to contact an outer surface 138 of the inner pipe 120. The insulation units 124 may have adjacent centralizers 126, configured to centralize or secure the inner pipe 120 within an outer pipe 122. The centralizers 126 may be of any number of shapes and designs configured to support and maintain the inner pipe 120 concentrically within the outer pipe 122. In some embodiments, a centralizer 130 may have a disk or washer-like shape, essentially comprising a short hollow cylinder. Alternately, a centralizer 132 may have a number of spacers 134 spaced around a band 136 configured to secure the blocks in a ring shape. Other configurations and types of centralizers are well-known and may be applied to the present disclosure.

FIG. 1 shows an example embodiment of an insulation unit 102. The insulation unit 102 comprises multiple clamshell pieces 104, 106, in some embodiments as part of a single unit joined by an integral or living hinge as described below. The clamshell pieces may be shaped as a half annular cylinder. In some embodiments the insulation unit 102 may have two clamshell pieces 104, while in other embodiments the insulation unit 102 may have three or more clamshell pieces 104. Regardless of the number of clamshell pieces 104, the insulation unit 102 is configured to completely surround a circumference of an inner pipe 120 when secured in place. An inner surface 114 of the clamshell pieces 104, 106 is configured to contact an outer surface 138 of the inner pipe 120. Between, the outer surface 116 of the insulation unit 102 and an inner surface of the outer pipe 122 is an air gap for further improving thermal resistance by preventing or reducing conduction. The air gap between the insulation unit 102 and the outer pipe 122 may vary from less than one inch to several inches. The two clamshell pieces 104, 106 of the insulation unit 102 each have a thickness configured to fill, or almost entirely fill a gap between the inner pipe 120 and the outer pipe 122 of the pipe-in-pipe system 100. In some embodiments, the thickness of the clamshell pieces 104, 106 may be in a range from % of an inch to 1% inches. Depending on the size of the space to be filled in the pipe-in-pipe system 100, the thickness of the clamshell pieces may also be greater than or smaller than the previously defined range. The clamshell pieces 104, 106 are each shaped as an extruded arc, or alternatively, as a half of a hollow cylinder or as a single unit with a living hinge. The diameter of the insulation unit 102 may vary depending on the inner pipe 120 and the outer pipe 122, but may for example have an outer diameter in a range of 8 inches to 14 inches. Greater or smaller diameters are envisioned, and may be implemented based on the dimensions of the particular pipe-in-pipe system 100. The length of the insulation unit 102 may vary depending on the particular application and environment, but may be in a range varying from 2 feet to 8 feet. Other lengths are envisioned and contemplated, and may be appropriate based on the particular embodiment of the pipe-in-pipe system 100. The clamshell pieces 104, 106 are hollow and formed of a rigid or semi-rigid material forming a shell. The shell of the clamshell pieces 104, 106 is configured to be filled with an insulation product such as aerogel.

The multiple clamshell pieces 104, 106 of the insulation unit 102 are configured to mate together to completely surround a circumference of the inner pipe 120. The clamshell pieces may also be configured to secure to one another with a releasable securing mechanism 110, 112. The releasable securing mechanism 110, 112 may be a two-part system such as a latch or flap. In other embodiments, the releasable securing mechanism 110, 112 may be built into the clamshell pieces. In some embodiments, the clamshell pieces 104, 106 may have a releasable securing mechanism 110, 112 on a first edge along the length of the clamshell piece 104, 106. On an opposite edge of the clamshell piece 104, 106, the two or more clamshell pieces may be joined by a hinging mechanism 108. Any mechanism suitable for allowing the two clamshell pieces 104, 106 to rotate or pivot relative to one another may be used. The hinge mechanism 108 and releasable securing mechanism 110, 112 may be used to switch the insulation unit 102 between an open configuration, in which the two clamshell pieces 104, 106 only have one edge adjacent each other, and a closed configuration, in which the releasable securing mechanism 110, 112 is closed or secured and the two clamshell pieces 104, 106 have two opposite edges adjacent each other to form a cylindrical shape.

The two clamshell pieces 104, 106 may, in some embodiments, be part of a single unit joined together along an edge with a living hinge. The living hinge is a thin flexible hinge or flexure bearing made from the same material as the two pieces it connects. The living hinge may be thinned or cut to allow the two pieces to bend along the line of the hinge.

The mating surfaces may be flat and configured to seal against a mating surface of another clamshell piece (not shown) to thermally seal the insulation around a pipeline. The mating surfaces may include foam or some other sealant to ensure a tight seal at the mating surfaces as well as the end surfaces. The sealant or foam may prevent the movement of gas particles and increase the thermal resistance at the joints of the clamshell pieces. In some embodiments, the mating surfaces may not be flat, but may have profiles to mate and seal together. In one illustrative example, the mating surfaces may include half-lap joints to seal and thereby increase the thermal resistance at the joint. Other joint designs will be understood by those with skill in the art including interlocking shapes, tongue and groove, and bead and cove shapes.

FIG. 1 displays an example method of securing an insulation unit 102 around an inner pipe 120 of a pipe-in-pipe system. According to the method, an insulation unit 102 is provided having two clamshell pieces 104, 106 pivotally connected to each other along a length of the clamshell pieces 104, 106 and a releasable securing mechanism 110, 112. The insulation unit 102 is brought adjacent to an inner pipe 120 of a pipe-in-pipe system 100 and the two clamshell pieces 104, 106 are rotated relative to each other to close around or surround the inner pipe 120. After surrounding the inner pipe 120, the releasable securing mechanism 110, 112 is secured to retain the insulation unit 102 in place.

In yet other embodiments, the releasable securing mechanism 110, 112 may comprise a band or strap to secure the clamshell pieces 104, 106 into a complete cylindrical shape. Any suitable releasable securing mechanism 110, 112 may be implemented, though a low-profile compact securing mechanism such as a strap, elastic band, tape, or other thin securement may require less space inside the internal space of the pipe-in-pipe system 100, thereby allowing for an increased amount of insulating material in the insulation unit 102.

In some embodiments, the clamshell pieces 104, 106 may be held in place surrounding the inner pipe 120 by a centralizer 126. A particular centralizer design may be implemented having a slot or channel configured to mate with the end 118 of a clamshell piece 104. A second similar centralizer may be implemented to secure the opposite end of the clamshell piece 104 and thereby secure the clamshell piece 104 concentrically around the inner pipe 120 and inside the outer pipe 122.

In some embodiments, the centralizers 126 may abut the insulation units 124 at each end of a number of insulation units 124. In other embodiments, centralizers 126 may have a number of insulation units 124 between adjacent centralizers 126. In further embodiments, the centralizers 126 may be configured to martially surround or secure an end of a centralizer 126. For example, a centralizer 126 may have a channel or groove at a diameter of the centralizer. The channel or groove may be contained between an outer circumference and an inner circumference of the centralizer 126. In other embodiments, the centralizer 126 may have a first flat or washer-like portion sized and configured to contact and sit adjacent to an end surface 140 of a centralizer 126. Around an outer circumference of the washer-like portion of the centralizer 126 is a retainer wall having a height or thickness greater than the thickness of the washer-like portion of the centralizer 126. The retaining wall of the centralizer 126 may have the washer-like portion located at a middle or center height, such that the retaining wall extends beyond the washer-like portion perpendicular to an axis of the centralizer 126 in both directions. When installed in a pipe-in-pipe system, the centralizer 126 as described herein secures adjacent insulation units 124 by contacting the washer-like portion against an end surface 140 of a centralizer 126. Meanwhile, an inner surface of the retaining wall of the centralizer 126 contacts an outer surface 142 of the centralizer 126. In this configuration, the insulation unit is held in place, and the multiple pieces or portions of the insulation unit 124 are secured tightly around the inner pipe 120. This configuration allows easy installation and simplifies the construction of the insulation unit 124 into two simple identical components.

In some embodiments, the centralizers 126 may have a snap closure or latch closure to reduce installation time and hassle. In such an embodiment, the centralizer 126 may be in an open or pre-installed configuration ready to surround or be placed around the circumference of the inner pipe 120. After wrapping or placing the centralizer 126 around the inner pipe 120, the snap closure or other securing mechanism may secure the centralizer in place and form a concentric ring to support the inner pipe 120 concentrically inside the outer pipe 122.

In some embodiments, the centralizers 126 may be integrated into or part of the insulation units 124. Rather than having insulation units 124 and separate centralizers 126, the ends of the insulation units 124 may incorporate a centralizer mechanism configured to support the weight of the inner pipe 120 and maintain it in a concentric or central location inside the outer pipe. In such a configuration, the installation of the insulation and centralizers may be quicker and more efficient.

FIG. 1 displays a method of assembling a pipe-in-pipe system 100 using an insulation unit 102. In a first step of the method, an inner pipe 120 is provided configured to convey a flow of material from a first location to a second location. A centralizer, 128 is placed around the inner pipe 120 and configured to secure the inner pipe 120 concentrically within an outer pipe 122. Next, an insulation unit 102 is provided adjacent to the inner pipe 120, the insulation unit 102 in an open or assembly configuration. The insulation unit 102 is placed with an inner surface 114 facing an outer surface 138 of the inner pipe 120. The insulation unit 102, comprising one or more clamshell pieces 104, 106 is closed or wrapped around the inner pipe 120. The insulation unit 102 is secured using a securing mechanism 110, 112. The insulation unit 102 is placed with one end resting adjacent the centralizer 128. Next a second centralizer 130 in placed at a second end of the insulation unit 102. Additional insulation units 102 and centralizers 130 are added onto the system to insulate the inner pipe 120. The inner pipe 120, insulation unit 102, and centralizers 128, 130 are sheathed in an outer pipe 122.

In an assembled configuration of the pipe-in-pipe system 100, a series of insulation units 124 are installed surrounding an inner pipe 120 and completely surrounded by an outer pipe 122. The insulation units 124 are secured with latches 144 according the embodiments described herein. Located between adjacent insulation units are centralizers 126, positioned such that a first side of the centralizer 126 contacts or is directly adjacent a first insulation unit 124 while a second side of the centralizer 126 contacts or is directly adjacent a second insulation unit 124.

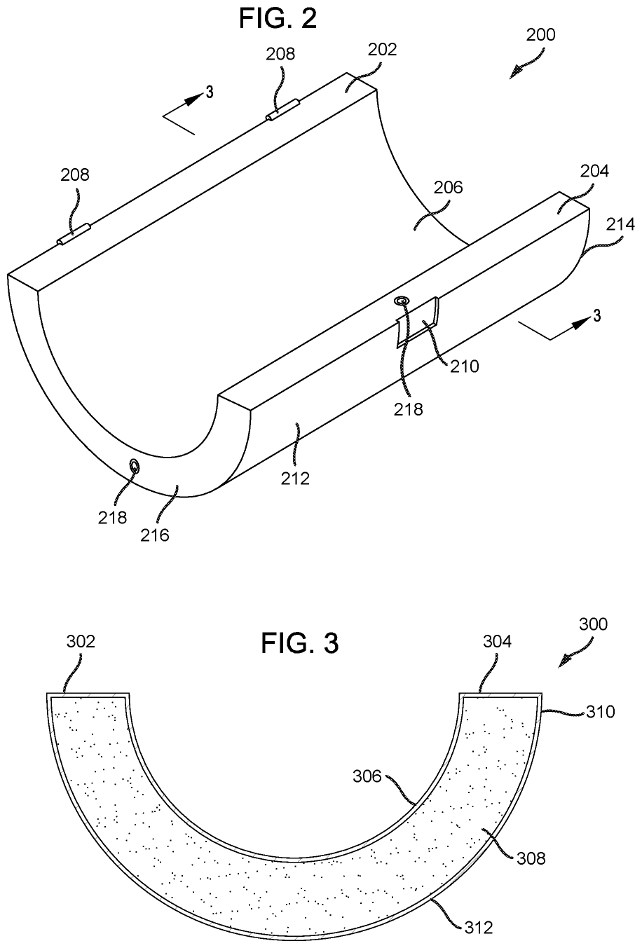

FIG. 2 shows an embodiment of an a clamshell piece 200. The modular insulation unit has a shape resembling an extruded U-shape, or alternatively a semi-ring cylinder. At a top end of the clamshell piece 200 are two mating surfaces 202, 204 which run the entire length of the clamshell piece 200 and are shaped or configured to interface with corresponding surfaces of a second clamshell piece to surround an inner pipe of a pipe-in-pipe system. An inner surface 206 of the clamshell piece 200 is shaped to receive an outer surface of the inner pipe and has a radius or curvature that matches the radius or curvature of the inner pipe. Between an outer surface 212 of the clamshell piece 200 and an inner surface of an outer pipe is an air gap. The inner surface 206, outer surface 212, mating surfaces 202, 204, and end surfaces 216, 214 enclose a hollow body which may be filled with an insulating material. The clamshell piece 200 may be a thin-walled shell having an internal void for insulation.

The mating surfaces 202 and 204 are flat and configured to seal against a mating surface of another clamshell piece (not shown) to thermally seal the insulation around a pipeline. The mating surfaces may include foam or some other sealant to ensure a tight seal at the mating surfaces 202 and 204 as well as the end surfaces 214 and 216. The sealant or foam may prevent the movement of gas particles and increase the thermal resistance at the joints of the clamshell pieces 200. In some embodiments, the mating surfaces 202 and 204 may not be flat, but may have profiles to mate and seal together. In one illustrative example, the mating surfaces 202 and 204 may include half-lap joints to seal and thereby increase the thermal resistance at the joint. Other joint designs will be understood by those with skill in the art including interlocking shapes, tongue and groove, and bead and cove shapes.

In some embodiments, along one edge of the mating surface 202 is a hinge mechanism 208. The hinge mechanism 208 is configured to pivotally or rotationally attach the clamshell piece 200 to a second clamshell piece 200. When connected, the two clamshell pieces 200 may close to form a ring-shaped cylinder capable of completely surrounding an inner pipe. In other embodiments, the hinge mechanism 208 may be replaced with a securing mechanism 210, or may not be present at all.

Along the mating surface 204 is a securing mechanism 210. The securing mechanism 210 is configured to secure, either permanently or releasably, the two clamshell pieces 200. The securing mechanism may incorporate a latch, snap, clip, or any other suitable securing device. When used in connection with the hinge mechanism 208, the clamshell pieces 200 may open and close to allow easy and quick installation into a pipe-in-pipe system. In some embodiments, as described above, the securing mechanism 210 may be in other locations on the clamshell piece 200 or may be of a band-type or centralizer designed to clamp and secure clamshell pieces 200.

A protective cladding may be applied as an outer layer surrounding the rest of the insulation system. In some embodiments, cladding may be formed of one or more layers of mass loaded vinyl bound to a metal jacketing, a metal layer only, and/or other combinations of protective materials may be used to form cladding. The protective cladding reduces emissivity and will further improve the insulating performance of the clamshell piece 200. Additional examples of protective cladding materials may include, but are not limited to, aluminum jacketing at 0.01-0.063″ thick as described in detail per ASTM C1729-16, stainless steel jacketing at 0.012-0.050″ thick per ASTM C1767-16 and ASTM1767M-16, laminate protective jacketing per ASTM C1775-14, chlorosulfonated polyethylene non-metallic jacketing available from ULVA Insulation Systems LTD, and/or combinations thereof. In some embodiments, the protective cladding may be applied to the inside of the clamshell piece.

According to some embodiments, the clamshell piece 200 may be filled, or a void inside the clamshell piece 200 may be filled with an insulating material. In some embodiments, the clamshell piece 200 may be filled with an insulating material through a filling port 218. The filling port 218 may be a sealable opening or hole through which insulation may be added. The filling port 218 may be located at one end at the end surface 216 of the clamshell piece or along the mating surface 204.) Various types of insulation are envisioned with the present disclosure, some of which may be poured as a liquid through the filling port 218 while others may be added by dumping, pouring, or blowing in insulating product. For example, insulating particles, such as small chunks or particles of aerogel may be inserted through the filling port 218. The small chunks or particles of insulating material may be a recycled product or may be trimmings or scrap produced in other insulating processes. By enabling the use of leftover or scrap insulation, in addition to any type of new possible insulating material, the cost of insulating the pipe-in-pipe system can be reduced. In some embodiments, more than one filling port 218 may be used to add the insulating material.

In some embodiments, the filling port may comprise an entire surface of the clamshell piece 200, such as the end surface 216. In such an embodiment larger blanket-type or other insulation may be used to fill the void of the clamshell piece. The filling port 218 may also allow the introduction of opacifiers or other additives. In some embodiments, the clamshell piece 200 may also serve as a vacuum insulation unit, with the filling port 218 configured to remove material, such as gases, from the internal void of the clamshell piece 200 providing additional insulation alternatives.

A method of manufacturing the clamshell piece 200 as shown in FIG. 2 may include steps such as forming or assembling a thin-walled body from a rigid or semi-rigid material such as a PVC, plastic, thermoplastic, or other suitable material. After forming the body of the clamshell piece 200, the insulation is added to a void in the clamshell piece 200. The insulation material may be added through a filling port 218. Filling the clamshell piece 200 with insulation may include pouring an insulating material through the filling port 218 or may include inserting an insulation material through another opening in the clamshell piece 200. After filling the clamshell piece 200 with insulation, the filling port 218 is closed or sealed to retain the insulation material inside the void or internal chamber of the clamshell piece 200.

FIG. 3 shows a section view 300 of the clamshell piece 200 from FIG. 2. The U shape of the clamshell piece 200 is shown, with upper surface 302, 304 oriented radially from the center of the radius of curvature. The upper surfaces 302, 304 may have any orientation, so long as the one or more clamshell pieces 200 are capable of fully surrounding an inner pipe and maximizing an insulation level around the inner pipe. The clamshell piece 200 comprises a thin shell 310 made from a rigid or semi-rigid material. The thin shell 310 is preferably as thin as practicably possible to maximize the volume and amount of insulation material 308 contained inside the thin shell 310. The inner surface 306 of the thin shell 310 has a first radius of curvature configured to match an external curvature of an inner pipe, while the outer surface 312 of the thin shell 310 has a radius of curvature configured to match and/or leave an air gap between the thin shell 310 and the inner surface of an outer pipe. In some embodiments, the mating surfaces of the clamshell units may have other profiles, such as half laps, tongue in groove, or other interlocking or interfacing profiles to increase thermal resistance at the joints and provide an improved thermal seal.

The insulation material 308 fill substantially all of the internal void of the thin shell 310. The insulation material 308 may be a shredded or particulate insulation, a solid insulation material, or any form of insulation which can fill the internal void of the thin shell 310. The insulation material 308 may be aerogel alone, aerogel combined with opacifiers, aerogel combined with filler particles, or any suitable insulation combination. The introduction of filler particles may reduce the insulation cost and thereby reduce the manufacturing cost of the insulating unit.

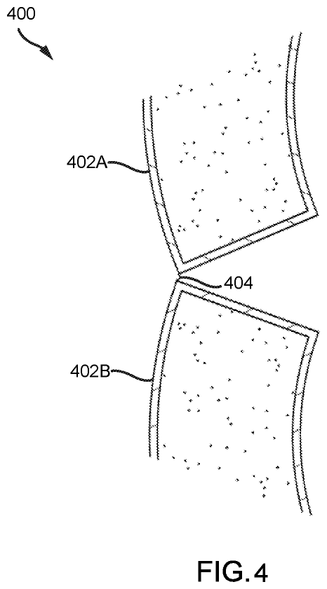

FIG. 4 depicts a cross section 400 of a hinge portion of an insulation unit. In this example embodiment, the two clamshell pieces 402A and 402B are joined or connected by a living hinge 404. The living hinge 404 is shown as a thinned portion made from the same semi-rigid material as the two clamshell pieces that allows the two clamshell pieces to rotate or pivot relative to each other and hinge together to form an annular cylinder described above. The living hinge 404 may be a thin flexible hinge or flexure bearing made from the same material as the two pieces it connects. The living hinge 404 may be thinned or cut to allow the two pieces to bend along the line of the hinge. In some embodiments, the living hinge may have cuts or portions removed, such as by laser cutting, to provide a kerf bend. The living hinge 404 may be formed at the same time as the two clamshell pieces 402A and 402B or may be affixed to each after they are formed.

The specification and drawings are, accordingly, to be regarded in an illustrative rather than a restrictive sense. It will, however, be evident that various modifications and changes may be made thereunto without departing from the broader spirit and scope of the disclosure as set forth in the claims. It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the description.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and these examples are not intended to limit the scope, applicability, or configuration of the description. Rather, the preceding description of the embodiments will provide those skilled in the art with an enabling description for implementing embodiments herein. Various changes may be made in the function and arrangement of elements without departing from the spirit and scope of the description.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. As used herein, the terms “top” and “bottom” can be associated with vertical positions when the air legs of the cleaning machine are oriented vertically. However, in some cases, the cleaning machine may use air legs or configurations in non-vertical directions, in in which case the terms “top” and “bottom” may refer to positions not vertical but oriented diagonally as well. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Having described several embodiments, it will be recognized by those of skill in the art that various modifications, alternative constructions, and equivalents may be used without departing from the spirit of the description. For example, the above elements may merely be a component of a larger system, wherein other rules may take precedence over or otherwise modify the application thereof. Also, a number of steps may be undertaken before, during, or after the above elements are considered. Accordingly, the above description should not be taken as limiting the scope of the disclosure.

What is claimed is:

1. An insulation device comprising:
a first and a second thin-walled shell, each defining a half annular cylinder and each defining an enclosed inner space;
insulating material filling the enclosed inner space of the first and the second thin-walled shell;
a hinge securing a first edge of the first thin-walled shell to a second edge of the second thin-walled shell, the hinge configured to allow the first and the second thin-walled shell to form an open and a closed configuration, wherein:
the first and the second thin-walled shells form an annular cylinder in the closed configuration so as to be configured to entirely enclose an inner pipe within the annular cylinder in the closed configuration; and
a securing mechanism to secure the first and the second thin-walled shells together when in the closed configuration.

2. The insulation device of claim 1, wherein the first and the second thin-walled shell are made of a lightweight, semi-rigid material.

3. The insulation device of claim 1, wherein the insulating material comprises aerogel particles.

4. The insulation device of claim 3, wherein the insulating material further comprises an opacifier.

5. The insulation device of claim 1, wherein the first and the second thin-walled shells are coated with a thin material configured to reduce an emissivity of the first and the second thin-walled shells.

6. The insulation device of claim 1, wherein the first and the second thin-walled shells each comprise half of a centralizer to centrally position the inner pipe within an outer pipe.

7. The insulation device of claim 1, wherein a length of the first and the second thin-walled shells is configured to fit between centralizers of a pipe-in-pipe system.

8. A method of insulating a pipe-in-pipe system, the method comprising:
opening a clamshell insulation unit;
closing the clamshell insulation unit around an inner pipe;
securing the clamshell insulation unit about the inner pipe;
providing a centralizer at a first end of the clamshell insulation unit, the centralizer concentric with the inner pipe; and
enclosing the inner pipe and the clamshell insulation unit in an outer pipe, the inner pipe positioned concentrically within the outer pipe by the centralizer.

9. The method of claim 8, wherein the clamshell insulation unit comprises:
a first and a second thin-walled shell, each defining a half annular cylinder having an enclosed inner space;
insulating material filling the enclosed inner space of the first and the second thin-walled shell; and
a hinge securing a first edge of the first thin-walled shell to a second edge of the second thin-walled shell, the hinge configured to allow the first and the second thin-walled shell to have an open and a closed configuration, wherein:
the first and the second thin-walled shells form an annular cylinder in the closed configuration; and
a securing mechanism to secure the first and the second thin-walled shells together when in the closed configuration.

10. The method of claim 8, wherein:
the clamshell insulation unit is a first clamshell insulation unit; and
wherein the method further comprises:
opening a second clamshell insulation unit;
closing the second clamshell insulation unit around the inner pipe;
positioning the second clamshell insulation unit adjacent to the first clamshell insulation unit; and
securing the second clamshell insulation unit about the inner pipe.

11. The method of claim 8, wherein:
the clamshell insulation unit is a first clamshell insulation unit; and
wherein the method further comprises:
opening a second clamshell insulation unit;
closing the second clamshell insulation unit around the inner pipe;
positioning the second clamshell insulation unit with a first end adjacent to the centralizer; and
securing the second clamshell insulation unit about the inner pipe.

12. The method of claim 11, wherein:
the centralizer is a first centralizer; and
the method further comprises:
positioning a second centralizer on the inner pipe, the inner pipe positioned concentrically within the outer pipe by the first and the second centralizers.

13. The method of claim 8, the method further comprising:
filling an enclosed inner space of the clamshell insulation unit with particles having a high thermal resistance value.

14. The method of claim 13, wherein the particles comprise:
aerogel particles.

15. A pipe-in-pipe insulation system comprising:
a first and a second hollow body extending along an axis and each having a half annular ring cross section perpendicular to the axis, wherein the first and the second hollow body are filled with an insulating material;
a hinging mechanism to allow the first hollow body to rotate relative to the second hollow body;
a securing mechanism configured to secure the first and the second hollow body together to form an annular cylinder which fits inside an outer pipe and through which an inner pipe passes; and
a centralizer configured to position the inner pipe concentrically within the outer pipe.

16. The pipe-in-pipe insulation system of claim 15, wherein the centralizer is affixed to a first end of the first and the second hollow body.

17. The pipe-in-pipe insulation system of claim 15, wherein the first and the second hollow body are thin-walled.

18. The pipe-in-pipe insulation system of claim 17, wherein the first and the second hollow body are formed of a lightweight rigid material.

19. The pipe-in-pipe insulation system of claim 15, wherein the centralizer comprises the first and the second hollow body when secured to form the annular cylinder.

20. The pipe-in-pipe insulation system of claim 15, wherein the insulating material comprises aerogel.
